(19) United States
(12) Patent Application Publication
(10) Pub. No.: US 2024/0427139 A1
(43) Pub. Date: Dec. 26, 2024

(54) DEVICE, METHOD AND PROGRAM FOR DESIGNING LOOP WIRING

(71) Applicant: NIPPON TELEGRAPH AND TELEPHONE CORPORATION, Tokyo (JP)

(72) Inventors: Keisuke MURAKAMI, Musashino-shi, Tokyo (JP); Hideaki MYANISHI, Musashino-shi, Tokyo (JP); Chihiro KITO, Musashino-shi, Tokyo (JP); Taku YAMANE, Musashino-shi, Tokyo (JP)

(73) Assignee: NIPPON TELEGRAPH AND TELEPHONE CORPORATION, Tokyo (JP)

(21) Appl. No.: 18/701,322

(22) PCT Filed: Oct. 29, 2021
(86) PCT No.: PCT/JP2021/040106

§ 371 Date: Apr. 15, 2024

(51) Int. Cl. G02B 27/00

(52) U.S. Cl. CPC G02B 27/0012

(57) ABSTRACT

In order to achieve the above object, a loop wiring designing apparatus according to the present disclosure creates loops in which optical fibers on a map are connected in a loop shape using input facility information and map information, deletes at least some of overlapping loops, having a certain amount of overlapping loop area or more surrounded by the loops on the map, of the created loops to cancel overlapping loops, on an occasion where a loop group, after cancelation of the overlapping loops includes a loop outside a demand number range, having an assumed demand number arising both inside and outside the loop being out of a demand number range set at discretion, repeats deletion of the loop out of the demand number range and re-cancelation of the overlapping loops, and designs a loop group including only loops in which the demand number falls within the demand number range as a selected loop group.

### DESCRIPTION

### Technical Field

The present disclosure relates to an apparatus, a method, and a program for designing loop wiring of an optical access network.

### Background Art

In the next generation communication service, an access communication network that ensures high reliability and can flexibly respond to demand fluctuations is required. As an access wiring method for satisfying this requirement, a concatenated loop topology type optical access network is being studied (refer to Non Patent Literature 1, for example).

### CITATION LIST

### Non Patent Literature

Non Patent Literature 1: Shingo Ohno et al., “Resilient na shakai wo sasaeru hikariakusesumoukouseihou (in Japanese) (Optical Access Network Design for Supporting Resilient Society)”, 2021 The Institute of Electronics, Information and Communication Engineers Society Conference, BK-2-2, 2021

### SUMMARY OF INVENTION

### Technical Problem

However, in the design of this concatenated loop topology type optical access network, an index for evaluating a loop shape has not been established from the viewpoint of determining whether high cost effectiveness in terms of installation cost coexists with efficient coverage of the arising demand. For this reason, in order to design a loop that satisfies required performance at low cost, it is necessary to check and evaluate the presence or absence of communication infrastructure facilities, the usage status thereof, and the assumed demand number one by one, and it is essential to perform computation and design manually by a person having access network design skills. This manual design causes a problem that a cost for securing operation of a person having design skills and design quality such as a required cable length are different for each designer.

In order to solve the above problem, an object of the present disclosure is to provide a loop wiring designing apparatus, method, and program capable of mechanically selecting a loop route having a high cost effectiveness with respect to the demand number to be covered, from map information and facility information, without depending on knowledge of a person having access network design skills.

### Solution to Problem

In order to achieve the above object, in the present disclosure, a loop having an overlapping loop area and having low cost effectiveness with respect to the demand number to be covered is deleted, and a loop is selected such that an assumed demand number to be covered falls within a demand number range set at discretion.

Specifically, a loop wiring designing apparatus according to the present disclosure is a loop wiring designing apparatus for an optical access network laid on a loop type path passing through a telecommunications carrier base facility, the loop wiring designing apparatus including: an input unit in which facility information including information on point facility capable of connecting optical fibers and connection route information indicating a route connected by optical fibers and map information indicating a location of each facility included in the facility information on a map are input; and a computation unit configured to: create loops in which optical fibers on the map are connected in a loop shape using the facility information and the map information; on an occasion where an initial loop group, including the created loops, includes overlapping loops having a certain amount of overlapping loop area or more surrounded by the loops on the map, delete at least some of the overlapping loops to cancel overlapping loops; on an occasion where the loop group, after cancelation of the overlapping loops, includes a loop outside a demand number range having a sum, being out of a demand number range set at discretion, of an assumed demand number arising inside the loop and an assumed demand number arising outside the loop at a facultative distance from the loop, obtained by calculation based on a preset demand number to be covered in each place, repeat deletion of the loop outside the demand number range from the loop group before cancelation of the overlapping loops and re-cancelation of the overlapping loops in regard to the loop group after deletion of the loop outside the demand number range to get the sum of each loop in the loop group after cancelation of the overlapping loops falling within the demand number range; and design a loop group including only loops in which the sum falls within the demand number range as a selected loop group.

Specifically, a loop wiring designing method according to the present disclosure is a loop wiring designing method for an optical access network laid on a loop type path passing through a telecommunications carrier base facility, the loop wiring designing method including: inputting facility information, including information on point facility capable of connecting optical fibers and connection route information indicating a route connected by optical fibers, and map information indicating a location of each facility included in the facility information on a map; creating loops in which optical fibers on the map are connected in a loop shape using the facility information and the map information; on an occasion where an initial loop group, including the created loops, includes overlapping loops having a certain amount of overlapping loop area or more surrounded by the loops on the map, deleting at least some of the overlapping loops to cancel overlapping loops; on an occasion where the loop group, after cancelation of the overlapping loops, includes a loop outside a demand number range having a sum, being out of a demand number range set at discretion, of an assumed demand number arising inside the loop and an assumed demand number arising outside the loop at a facultative distance from the loop, obtained by calculation based on a preset demand number to be covered in each place, repeating deletion of the loop outside the demand number range from the loop group before cancelation of the overlapping loops and re-cancelation of the overlapping loops in regard to the loop group after deletion of the loop outside the demand number range to get the sum of each loop in the loop group after cancelation of the overlapping loops falling within the demand number range; and designing a loop group including only loops in which the sum falls within the demand number range as a selected loop group.

Specifically, a program according to the present disclosure is a program for instructing a computer to function as the loop wiring designing apparatus.

### Advantageous Effects of Invention

According to the present disclosure, it is practical to provide a loop wiring designing apparatus, method, and program capable of mechanically selecting a loop route having high cost effectiveness with respect to the demand number to be covered, from map information and facility information, without depending on knowledge of a person having access network design skills.

### BRIEF DESCRIPTION OF DRAWINGS

FIG. 1 is a diagram illustrating an example of a method for designing loop wiring according to an embodiment.

FIG. 2 is a diagram illustrating setting of a loop according to an embodiment.

FIG. 3 is a diagram illustrating a point facility to be a loop setting target according to an embodiment.

FIG. 4 is a diagram illustrating an example of a concatenated loop topology type optical access network according to an embodiment.

FIG. 5 is a diagram illustrating deletion of a self-intersecting loop according to an embodiment.

FIG. 6 is a diagram illustrating deletion of a loop having an overlapping area according to an embodiment.

FIG. 7 is a diagram illustrating a list according to an embodiment.

FIG. 8 is a diagram illustrating deletion of a loop based on a desired loop area according to an embodiment.

FIG. 9 is a diagram illustrating loop creation of a concatenated loop topology type optical access network according to an embodiment.

FIG. 10 is a diagram illustrating loop creation of a concatenated loop topology type optical access network according to an embodiment.

### DESCRIPTION OF EMBODIMENTS

Hereinafter, embodiments of the present disclosure will be described in detail with reference to the drawings. Note that the present disclosure is not limited to the embodiments described below. These embodiments are merely examples, and the present disclosure can be carried out in forms with various modifications and improvements based on the knowledge of those skilled in the art. Components having the same reference numerals in the present specification and the drawings are the same components.

### Embodiment

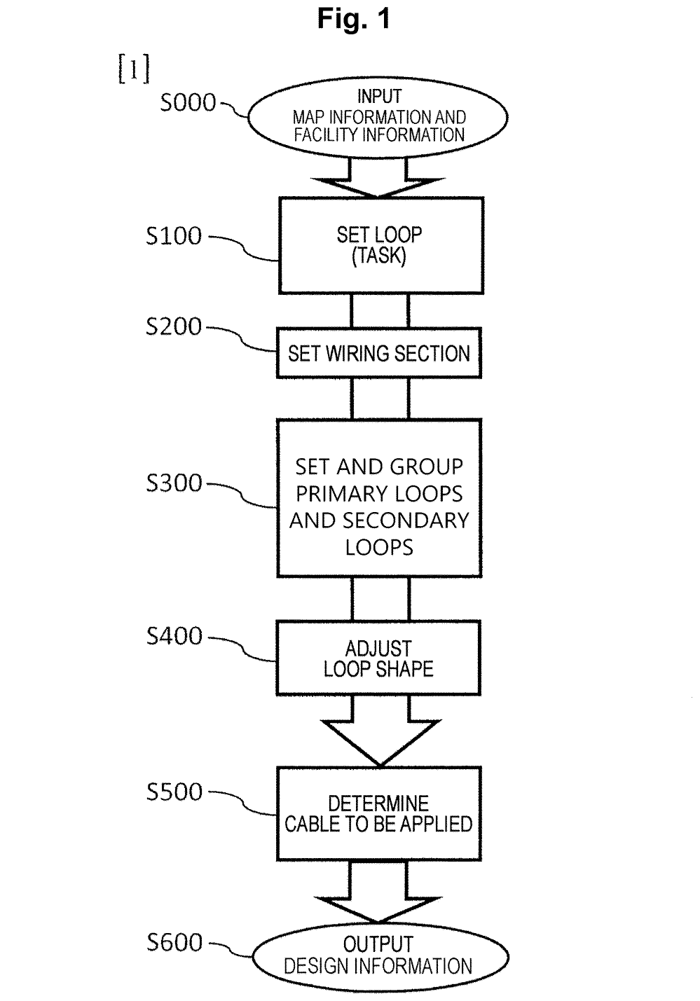

A method of designing a concatenated loop topology type optical access network performed by a loop wiring designing apparatus will be described using FIG. 1. First, map information and facility information are input (step S000). The map information may include demand number information assumed for each area or place, information on possibility or impossibility of laying an optical fiber in each area or place, and the like. The facility information may include point facility information including a type of a point facility such as a communication base station, a manhole, or a utility pole, location of the point facility, a usage status of the point facility, and the like, connection route information between point facilities, and the like. Examples of location of a point facility can include the longitude, latitude, and the like of the point facility.

On the basis of the input map information and facility information, loops in which optical fibers can be connected in a loop shape are set on a map such that an assumed demand number in a loop and a peripheral area within 700 m from the loop is 100 to 300 demands (step S100).

An area to be covered by each set loop is set as each wiring section on the map (step S200). For example, a peripheral area within 700 m from a loop may be set as a wiring section on the map. Note that, as for a part where wiring sections overlap between loops, any one of the loops may be selected at discretion as the wiring section.

A loop starting from a communication base station and a loop starting from a manhole directly connected to a cable tunnel are set as primary loops (step S300). Note that, depending on a facility situation, a loop starting from a utility pole may be set as a primary loop. Loops other than primary loops are set as secondary loops, and grouping is performed such that the number of secondary loops connected to one primary loop becomes 0 to 4 (step S300). When the number of secondary loops is 5 or more, the primary loops and the secondary loops are grouped again such that the number of secondary loops becomes 0 to 4. Note that, an access network that is not a concatenated loop topology type including primary loops and secondary loops, step S300 may not be performed.

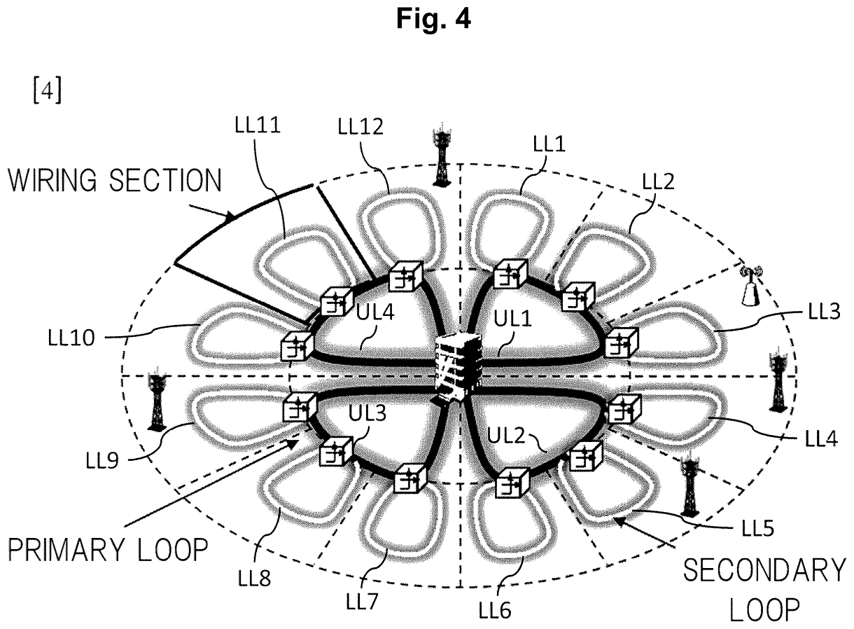

FIG. 4 illustrates an example of a concatenated loop topology type optical access network having primary loops and secondary loops. The optical access network of FIG. 4 includes primary loops UL1 to UL4 and secondary loops LL1 to LL12. In addition, LL1 to LL3 are connected to UL1, LL4 to LL6 are connected to UL2, LL7 to LL9 are connected to UL3, and LL10 to LL12 are connected to UL4. In this example, since three secondary loops are connected to each of the primary loops UL1 to UL4, it can be said that there is no problem in grouping.

In addition, when another loop shape can also be selected in a wiring section, the loop shape is examined on the basis of the fact that the area surrounded by a loop is about 40% of the area of the wiring section (step S400). Then, a laying length of a wiring cable is minimized.

The required number of core wires of the primary loops is calculated using Formula (1), and the required number of core wires of the secondary loops is calculated using Formula (2) (step S500).

(Math. 1)

(Assumed demand number of loop+spare core wire)÷2+number of secondary loop cable core wires to be connected (1)

(Math. 2)

(Assumed demand number of loop+spare core wire)÷2 (2)

Then, cable integration in a route overlapping section is examined in consideration of economy and availability of infrastructure on the basis of the facility information. Note that, in an access network that is not a concatenated loop topology type including primary loops and secondary loops, the required number of core wires of each loop may be calculated using Formula (2).

In step S100 in the conventional method, there is no index for evaluating a loop shape from the viewpoint of determining whether high cost effectiveness in terms of the installation cost coexists with efficient coverage of arising demands.

The present disclosure provides the index. Specifically, by inputting map information and facility information, it is practical to mechanically select a loop route having a function (sufficient amount of facilities in consideration of reliability and flexibility to demand fluctuation) as an optical access network, in consideration of the presence or absence of communication infrastructure facilities, the usage status thereof, and an assumed demand number, and having a high cost effectiveness with respect to the demand number to be covered, and it is practical to design a loop network at a high speed by a computer without depending on knowledge of a person having access network design skills.

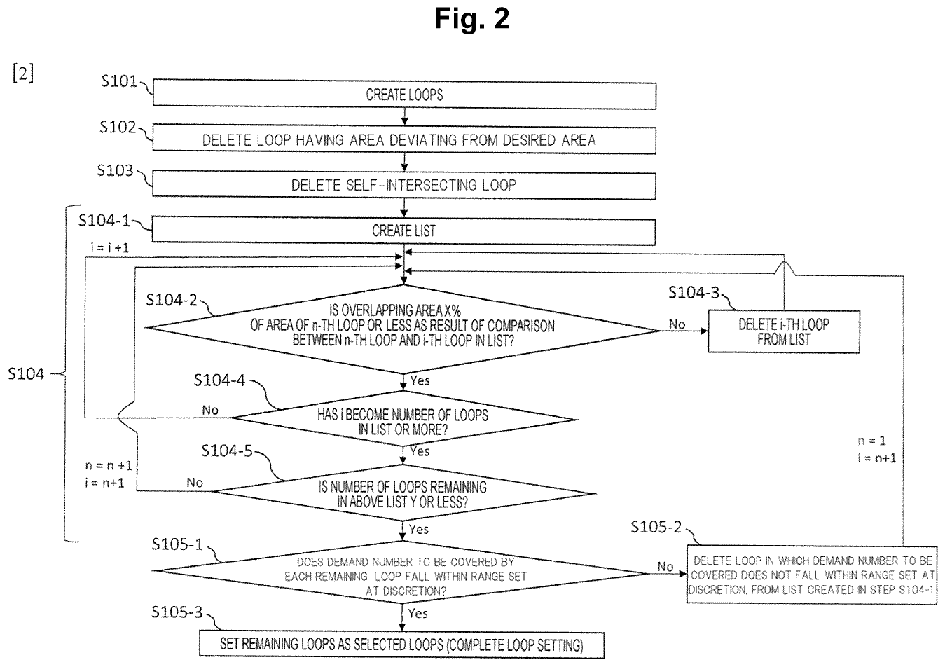

The loop wiring designing apparatus according to the present embodiment includes an input unit 11, a computation unit 12, and an output unit 13. The input unit 11 performs step S000, the computation unit 12 performs steps S100 to S500, and the output unit 13 performs step S600. Hereinafter, an example of a concatenated loop topology type optical access network designing method according to the present disclosure performed by the computation unit 12 is illustrated in FIG. 2. However, the present disclosure can also be implemented in design of a general loop, which is not a concatenated loop topology type. The loop wiring designing apparatus of the present disclosure can also be implemented on a computer and in a program, and the program can be recorded on a recording medium or provided through a network.

In the loop wiring designing method according to the present disclosure, step S100 is realized by the following configuration of steps S101 to S105. Here, step S104 further includes steps S104-1 to S104-5. Further, step S105 further includes steps S105-1 to S105-3. Each step will be described below with reference to FIGS. 2 to 7. FIG. 2 illustrates an example of a loop setting procedure according to the present embodiment.

### (Step S101)

From map information and facility information input through the input unit 11, a point facility (communication base station, manhole, utility pole, or the like) extending a connection route of two ways or less is excluded from a target for searching a loop constituent point facility with connection route information of the point facility left, and all loops starting from each of a communication base station, a manhole directly connected to a cable tunnel, and a utility pole are created.

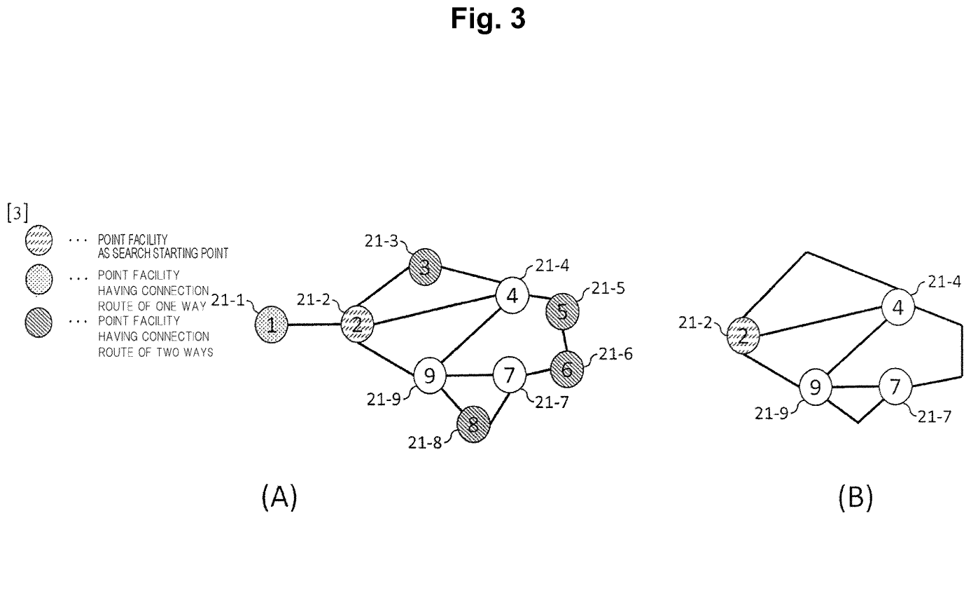

For example, it is assumed that node search (processing of searching for a route returning to a point facility as a starting point, that is, a loop, by repeating searching for a point facility connected to the point facility as the starting point and further searching for a point facility connected to the connected point facility) is performed from a point facility 21-2 selected as a starting point as illustrated in FIG. 3, and thus nine point facilities 21-1 to 21-9 are searched as illustrated in FIG. 3(A). Then, as illustrated in FIG. 3(B), the point facilities 21-1, 21-3, 21-5, 21-6, and 21-8 whose connection routes are two ways or less are excluded from the target for searching the loop constituent point facility with connection route information left. As a result, in the present embodiment, the number of point facilities is nine in FIG. 3(A), whereas the number of point facilities is four in FIG. 3(B).

Accordingly, it is practical to delete a point facility that does not contribute to the number of loop creation patterns as a route branch point without changing the shape of the connection route, and thus it is practical to reduce the amount of computation at the time of loop creation. However, regarding two or more routes arising between two point facilities such as between the point facility 21-2 and the point facility 21-4 in FIG. 3(B), loop search is performed by regarding the routes as different routes.

Although a connection route is represented by a straight line connecting point facilities in FIGS. 3(A) and 3(B), the connection route is not limited to the straight line and may be a curve. For example, since manholes as point facilities are connected in the ground, a connection route connecting the manholes can be curved.

### (Step S102)

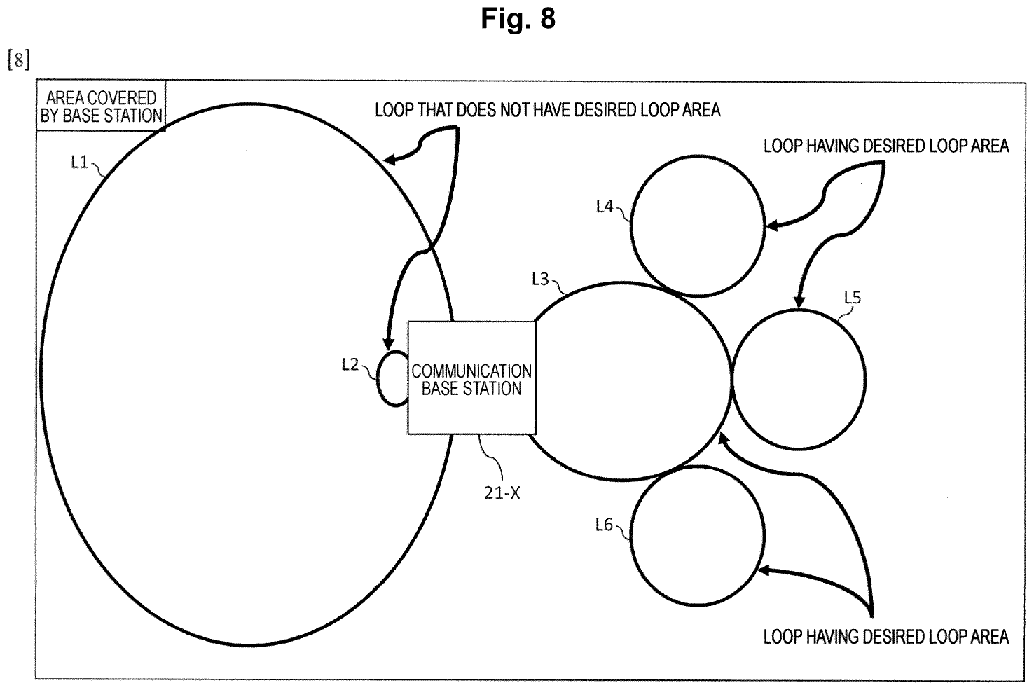

A loop having a size deviating from a desired loop area is deleted. The desired loop area can be set to any size, and for example, in a concatenated loop type topology optical access network, the desired loop area may be set to an area of 1/16 to 1/12 of the entire area of the area covered by a communication base station. Specifically, as illustrated in FIG. 8, regarding loops L1 to L6 have been created in an area to be covered by a communication base station 21-X, when an area of 1/16 to 1/12 of the entire area to be covered by the communication base station is set as a loop having a desired loop area, the loops L1 and L2 that do not have the desired loop area are deleted. By performing this process, it is practical to delete a loop significantly deviated from a desired shape and reduce the amount of computation in subsequent processes with appropriate loops kept staying. Note that the loop area refers to an area of a field surrounded by a loop on the map.

### (Step S103)

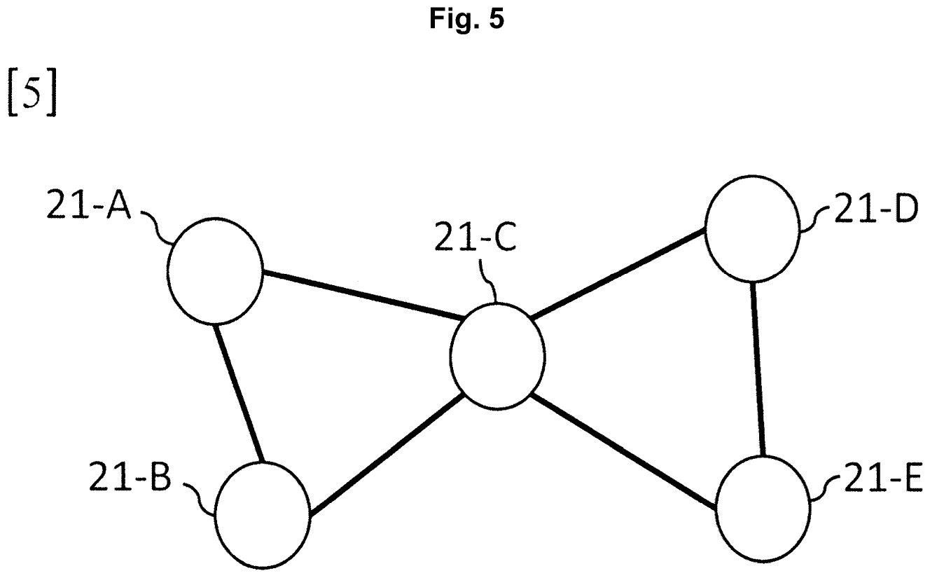

From the created loops, a loop self-intersecting like a letter 8, which is constructed through point facilities 21-A to 21-E illustrated in FIG. 5, is deleted. By performing this process, it is practical to delete a loop that cannot be used as a loop network and reduce the amount of computation in subsequent processes.

### (Step S104)

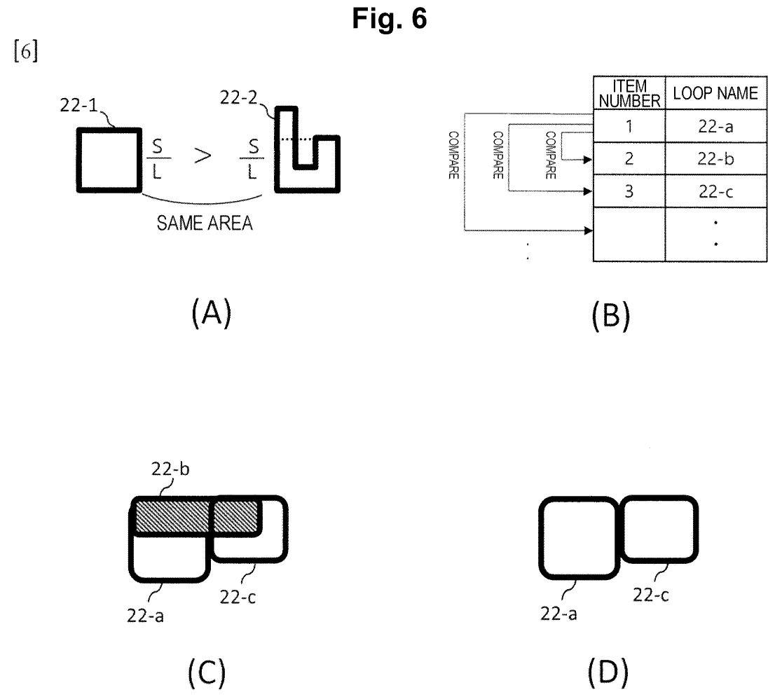

First, the loop shape is evaluated. Regarding all the remaining loops, S/L (or S/L²) is calculated with the loop area formed on the map set to S and the loop circumferential length set to L, and a list of arrangement in descending order of S/L (or S/L²) is created (step S104-1). As illustrated in the loops 22-1 and 22-2 of FIG. 6(A), as S/L (or S/L²) is large under the same area, the laying cable length can be shortened with demand in the area covered efficiently, and thus it is practical to evaluate cost effectiveness regarding the demand number, to be covered, by evaluating S/L (or S/L²).

Next, in steps S104-2 to S104-4 illustrated in FIG. 2, evaluation of overlapping areas between loops and deletion of an overlapping loop are performed in order from the top in the created list. In the present embodiment, attention is paid to an n-th loop from the top of the list, and evaluation of an overlapping area between the n-th loop and an i-th loop below the n-th loop and deletion of an overlapping loop are performed. An initial value of n is 1, and an initial value of i is n+1.

In the list created in step S104-1, an overlapping area between the first (corresponding to n=1 in FIG. 2) loop and the second (corresponding to i=2 in FIG. 2) loop from the top is evaluated (step S104-2), and on condition that the overlapping area is X % of the area of the first loop or more, the second loop is deleted (step S104-3). On condition that the overlapping area between the first loop and the second loop is X % of the area of the first loop or less, the second loop is kept staying. Subsequently, an overlapping area between the first loop and the third (second, on condition that the second loop gets deleted, the same applies hereinafter: the third loop moves up and turns into a second loop) loop is evaluated, and on condition that the overlapping area is X % of the area of the first loop or more, the third loop is deleted. On condition that the overlapping area between the first loop and the third loop is X % of the area of the first loop or less, the third loop is kept staying.

In this way, evaluation of the overlapping area between the first loop and each of all the loops below the first loop in the list and deletion of overlapping loops are performed (step S104-4). Completion of processing of evaluating overlapping areas and deleting overlapping loops with respect to the first loop is followed by checking whether the number of loops remaining in the list is Y or less (step S104-5). When the number of loops remaining in the list is more than Y, similar processing is performed on the second loop remaining in the list. Processing from step S104-2 to step S104-5 is comprehensively performed on all the loops remaining in the list until the number of loops remaining in the list is Y or less, and Y or less remaining loops are set as finally selected loops. For example, the value of X can be set to any value, and for example, X=10 may be set. Further, the value of Y can be set to any value, and for example, Y=10 may be set.

An example of a state in which loop areas overlap is illustrated in FIG. 6(C). In FIG. 6(C), a loop 22-b has an overlapping area with each of a loop 22-a and a loop 22-c. FIG. 6(B) illustrates an example of a list, created in step S104-1, including the loops 22-a, 22-b, and 22-c illustrated in FIG. 6(C). In the list illustrated in FIG. 6(B), the loops are arranged from the top in descending order of S/L (or S/L²), and the item number represents the order counted from the top. It is assumed that the list illustrated in FIG. 6(B) includes item numbers up to 5 for description, and item numbers 4 and 5 are not shown. Steps S104-2 to S104-5 will be described using the list illustrated in FIG. 6(B) as an example.

First, since initial values in FIG. 2 are n=1 and i=n+1, the overlapping area between the loop 22-a having item number 1 (first) and the loop 22-b having item number 2 (second) is compared (step S104-2). Here, it is assumed that X=10, the overlapping area between the loop 22-a and the loop 22-b is 10% of the loop area of the loop 22-a or more, and the loop 22-b is deleted (step S104-3). As a result, as illustrated in FIG. 6(D), the overlapping area between the loops is canceled.

Then, the loop 22-c having item number 3 moves up to item number 2 (not illustrated), and the overlapping area between the loop 22-a entered in item number 1 and the loop 22-c complete with moving up to item number 2 is compared (step S104-2). As illustrated in FIGS. 6(C) and 6(D), the loop 22-a and the loop 22-c do not overlap, and thus the loop 22-c is kept staying in the list. At this point, since the loop 22-c is entered in item number 2, i is 2, and the number of loops in the list is four resulted from deletion of the loop 22-b, then 1 is added to i, and processing returns to step S104-2 (step S104-4). That is, the overlapping area between the loop 22-a entered in item number 1 and a loop (not illustrated) entered in item number 3 anew (old item number 4) by moving-up is compared (step S104-2).

In this way, an overlapping area between the loop 22-a having item number 1 and each of the rest loops entered in item numbers subsequent thereto is compared, and on an occasion where the number of loops eventually remaining in the list is larger than Y, an overlapping area between the loop 22-c entered in item number 2 (old item number 3) and each of the rest loops entered in item numbers subsequent thereto is similarly compared (step S104-5).

By performing this process, it is practical to mechanically select loop groups independent from each other with high cost effectiveness regarding the demand number to be covered and a low degree of overlap.

### (Step S105)

The sum of assumed demands arising inside a loop and assumed demands arising outside the loop and at a facultative distance (within 500 [m] in the present embodiment, but which is not limited thereto.) from the loop route is defined as the demand number to be covered by the loop, and checking whether the demand number to be covered by each loop, remaining in the list immediately after processing in step S104, falls within a demand number range set at discretion is executed (step S105-1). In the present embodiment, the demand number range may be set to 100 to 300 cores per loop, but is not limited thereto. When there is a loop in which the demand number to be covered does not fall within the demand number range, the loop in which the demand number to be covered does not fall within the demand number range is deleted from the list before overlapping loop deletion processing (processing from step S104-2 to step S104-5), that is, the list created in step S104-1 (step S105-2), and overlapping loop deletion processing (processing from step S104-2 to step S104-5) is performed again using the list after step S105-2. When the demand number to be covered by each loop remaining in the list falls within the demand number range, each remaining loop is set as a selected loop (step S105-3).

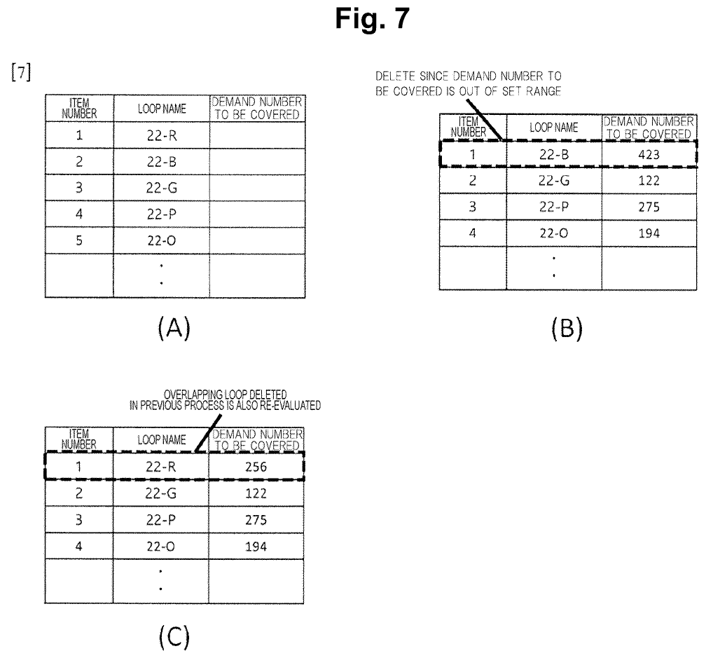

The list illustrated in FIG. 7(A) is the list created in step S104-1. The list illustrated in FIG. 7(B) is a list after step S104-5, and the demand number to be covered by each loop is entered in the list in step S105-1. As illustrated in FIGS. 7(A) and 7(B), a loop 22-R is deleted as a result of performing overlapping loop deletion processing (processing from step S104-2 to step S104-5) on the list illustrated in FIG. 7(A). Further, the list illustrated in FIG. 7(C) is the list after step S105-3.

When the demand number range is 100 to 300 cores per loop, a loop 22-B in the list illustrated in FIG. 7(B) exceeds the demand number range (step S105-1). Therefore, in step S105-2, the loop 22-B is deleted from the list illustrated in FIG. 7(A) and created in step S104-1, and overlapping loop deletion processing (processing from step S104-2 to step S104-5) is repeated again with the list including the deleted loop 22-R until all the demand number to be covered by each loop remaining in the list falls within the demand number range. Then, loops remaining in the list illustrated in FIG. 7(C) in which all the demand numbers to be covered by loops remaining in the list fall within the demand number range are set as selected loops. Note that the demand number to be covered entered in the lists of FIGS. 7(B) and 7(C) may be obtained by calculation based on demand number information assumed in each place included in the input map information.

By performing this process, it is practical to select a loop covering an appropriate demand number. In this process, an appropriate loop group can be finally selected as a loop network.

When constructing a concatenated loop topology type optical access network, similarly to step S101, a point facility extending a connection route of two ways or less is excluded from point facilities, identified from the map information and the facility information input through the input unit 11 and located on any loop starting from a point facility on the loops (for example, UL1 to UL4 illustrated in FIG. 4) selected in step S105-3, with connection route information left, a loop is created again starting from a manhole or a utility pole on the loops (for example, UL1 to UL4 illustrated in FIG. 4) selected in step S105-3 using the remaining point facilities, and steps S102 to S105 are performed on the loop created, again.

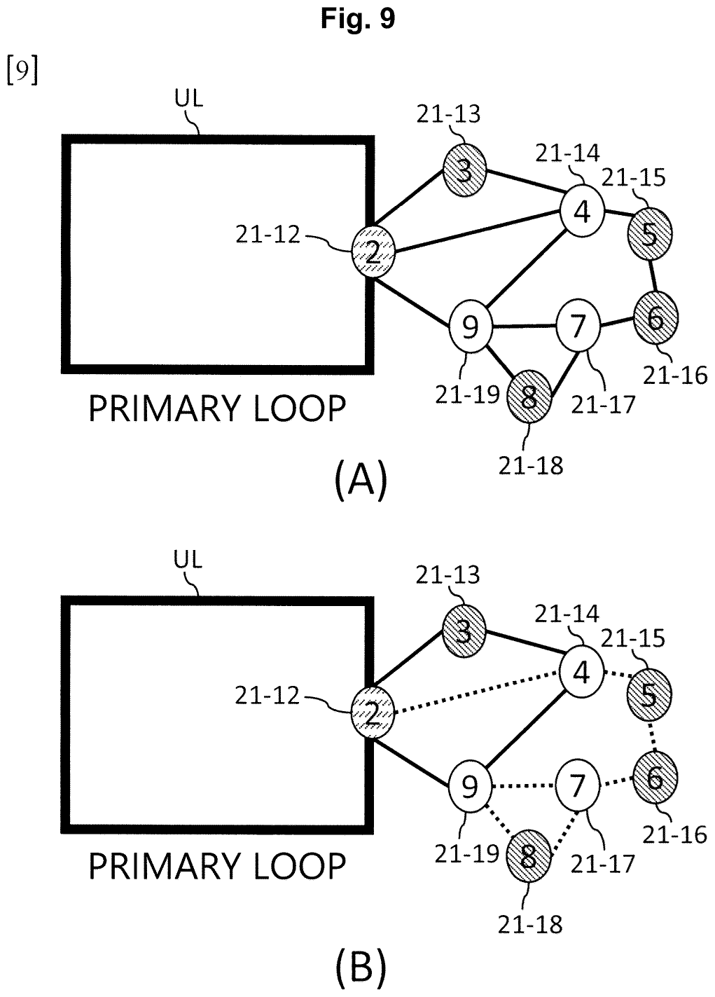

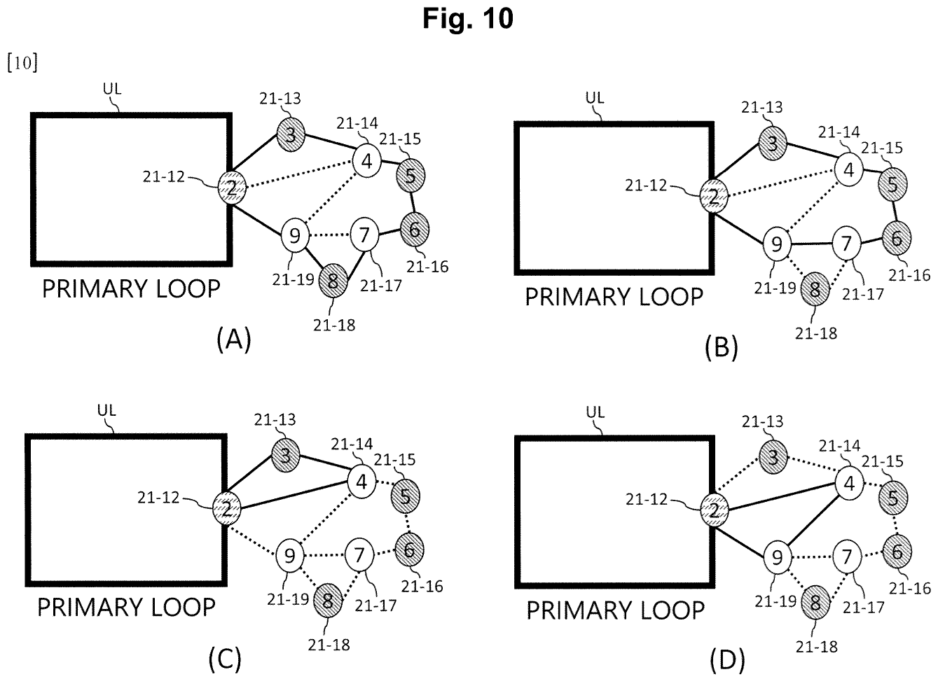

Here, a loop starting from a point facility on the loops selected in step S105-3 will be described with reference to FIGS. 9 and 10. FIG. 9(A) is an example of a result of performing node search starting from a point facility 21-12 on a primary loop UL as a selected loop, and illustrates seven point facilities 21-13 to 21-19 searched by the node search. In this example, as a loop starting from the point facility 21-12 on the primary loop UL, a loop indicated by a solid line in FIGS. 9(B) and 10(A) to (D) and the like can be exemplified. Therefore, in a node search result as illustrated in FIG. 9(A), as to point facilities on any of the loops as illustrated in FIGS. 9(B) and 10(A) to (D), point facilities (point facility 21-13, point facility 21-15, point facility 21-16, and point facility 21-18 in FIGS. 9 and 10) having connection routes of two ways or less are excluded with connection route information left.

The present disclosure is characterized by mechanically realizing appropriate loop selection having high cost effectiveness with respect to the demand number to be covered, at a high speed, through a method of reducing the number of point facilities to be searched in loop search in step S101, deleting inappropriate loops illustrated in steps S102 and S103 to reduce the amount of computation, and evaluating loops.

In addition, the present disclosure is characterized in that steps S101, S102, and S103 contribute to prevention of increase in the amount of computation to an extent making a computer inexecutable, step S104 contributes to highly cost-effective mechanical evaluation of the demand number to be covered by the loop network, and step S105 contributes to mechanical evaluation of the demand number to be covered by each loop.

### ADVANTAGEOUS EFFECTS OF INVENTION

By inputting map information and facility information to the algorithm of the present invention, it is practical to mechanically design a loop network required by a loop topology type optical access network, using a computer, and thus there is a cost reduction effect from the viewpoint that it is not necessary to ensure the operation of a person having access network design skills. In addition, since it is practical to mechanically select a loop topology network suitable for a loop type optical access network, using a computer, there is an effect that it is practical to ensure required design quality without depending on knowledge of a person having access network design skills.

### INDUSTRIAL APPLICABILITY

The apparatus, method, and program for designing loop wiring according to the present disclosure can be applied to an information communication industry.

### REFERENCE SIGNS LIST

10 Loop wiring designing apparatus
11 Input unit
12 Computation unit
13 Output unit
21 Point facility

### 22 Loop

1. A loop wiring designing apparatus for an optical access network laid on a loop type path passing through a telecommunications carrier base facility, the loop wiring designing apparatus comprising:
an input unit in which facility information, including information on point facility capable of connecting optical fibers and connection route information indicating a route connected by optical fibers, and map information indicating a location of each facility included in the facility information on a map are input; and
a computation unit configured to:
create loops in which optical fibers on the map are connected in a loop shape using the facility information and the map information;
on an occasion where an initial loop group, including the created loops, includes overlapping loops having a certain amount of overlapping loop area or more surrounded by the loops on the map, delete at least some of the overlapping loops to cancel overlapping loops;
on an occasion where the loop group, after cancelation of the overlapping loops, includes a loop outside a demand number range having a sum, being out of a demand number range set at discretion, of an assumed demand number arising inside the loop and an assumed demand number arising outside the loop at a facultative distance from the loop, obtained by calculation based on a preset demand number to be covered in each place, repeat deletion of the loop outside the demand number range from the loop group before cancelation of the overlapping loops and re-cancelation of the overlapping loops in regard to the loop group after deletion of the loop outside the demand number range to get the sum of each loop in the loop group after cancelation of the overlapping loops falling within the demand number range; and
design a loop group including only loops in which the sum falls within the demand number range as a selected loop group.

2. The loop wiring designing apparatus according to claim 1, wherein
the computation unit performs creation of the loop by excluding a point facility, extending a connection route of two ways or less, from point facilities identified from the facility information, with connection route information left, and creating loops starting from the remaining point facilities, and
the initial loop group is a loop group including loops obtained by deleting a loop, having the loop area outside a predetermined range, from the created loops.

3. The loop wiring designing apparatus according to claim 1, wherein
on an occasion where the selected loop group has already been set, the computation unit performs creation of the loop by excluding a point facility, extending a connection route of two ways or less, from point facilities identified from the facility information and arranged on any loop starting from a point facility on each of the loops in the selected loop group, with connection route information left, and creating loops starting from point facilities on each of the loops in the selected loop group using the remaining point facilities, and
the initial loop group is a loop group including loops obtained by deleting a loop, having the loop area outside a predetermined range, from the created loops.

4. The loop wiring designing apparatus according to claim 3, further comprising an output unit configured to output design information including the selected loop group,
wherein the computation unit is configured to:
set a wiring section on the map for each of the loops in the selected loop group;
group the loops in the selected loop group into a primary loop and a secondary loop;
select a loop to be used under predetermined conditions, on an occasion where there is a plurality of loops in the wiring section; and
determine how many core wires each of the loops has, based on the selected loop group, the sum regarding each of the loops, the grouping, and the selection of the loop.

5. The loop wiring designing apparatus according to claim 1, wherein
the computation unit
calculates S/L (or S/L²), in regard to all the loops in the initial loop group, with a loop area set to S and a loop circumferential length set to L, creates a list of arrangement in descending order of S/L (or S/L²), and
perform cancelation of the overlapping loops by performing processing of evaluating an overlapping area on the map between a loop area of a comparison source loop and each loop area of comparison destination loops with a head loop in the descending order of the list set to the comparison source loop and loops that are each lower, in the descending order, than the comparison source loop set to the comparison destination loops, and deleting a comparison destination loop, in which the overlapping area is an overlapping area ratio set at discretion from the list while changing the comparison source loop in accordance with the descending order until the number of loops remaining in the list becomes a predetermined number,
the loop group before cancellation of the overlapping loop is a loop group entered in the created list, and
the loop group after cancellation of the overlapping loop is a loop group entered in the list after the cancellation of the overlapping loop.

6. A loop wiring designing method for an optical access network laid on a loop type path passing through a telecommunications carrier base facility, the loop wiring designing method comprising:
inputting facility information, including information on point facility capable of connecting optical fibers and connection route information indicating a route connected by optical fibers, and map information indicating a location of each facility included in the facility information on a map;
creating loops in which optical fibers on the map are connected in a loop shape using the facility information and the map information;
on an occasion where an initial loop group, including the created loops, includes overlapping loops having a certain amount of overlapping loop area or more surrounded by the loops on the map, deleting at least some of the overlapping loops to cancel overlapping loops;
on an occasion where the loop group, after cancelation of the overlapping loops, includes a loop outside a demand number range having a sum, being out of a demand number range set at discretion, of an assumed demand number arising inside the loop and an assumed demand number arising outside the loop at a facultative distance from the loop, obtained by calculation based on a preset demand number to be covered in each place, repeating deletion of the loop outside the demand number range from the loop group before cancelation of the overlapping loops and re-cancelation of the overlapping loops in regard to the loop group after deletion of the loop outside the demand number range to make the sum of each loop in the loop group after cancelation of the overlapping loops falling within the demand number range; and
designing a loop group including only loops in which the sum falls within the demand number range as a selected loop group.

7. A non-transitory computer-readable storage medium storing a program for instructing a computer to function as the loop wiring designing apparatus according to claim 1.
